(19) United States
(12) Patent Application Publication
(10) Pub. No.: US 2020/0210232 A1
(43) Pub. Date: Jul. 2, 2020

(54) INFORMATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventor: Yukio KUMAZAWA, Kanagawa (JP)

(73) Assignee: FUJI XEROX CO., LTD., Tokyo (JP)

(21) Appl. No.: 16/392,574

(22) Filed: Apr. 23, 2019

(30) Foreign Application Priority Data
Dec. 26, 2018 (JP) 2018-242828

(51) Int. Cl. G06F 9/48; G06F 9/50

(52) U.S. Cl. CPC G06F 9/4881; G06F 9/5011

(57) ABSTRACT

An information processing apparatus includes an execution section that executes a series of processes according to an execution instruction which is formed to include a series of execution commands, and an execution control section that, in a case where execution of the series of processes by the execution section is stopped in the middle of the execution and, thereafter, is executed again, controls the execution section to not execute a first process according to a first execution command, which is decided in advance, among the series of execution commands, and to perform re-execution from a second process according to a second execution command other than the first execution command among the series of execution commands.

### CROSS-REFERENCE TO RELATED APPLICATIONS

This application is based on and claims priority under 35 USC 119 from Japanese Patent Application No. 2018-242828 filed Dec. 26, 2018.

### BACKGROUND

### (i) Technical Field

The present invention relates to an information processing apparatus and a non-transitory computer readable medium storing a program.

### (ii) Related Art

In recent years, a control device (for example, refer to JP5840266B) is proposed which, in a case where a plurality of jobs are cooperated and are executed as a job cooperation, controls execution of a job subsequent to a precedent job according to a result acquired by executing the precedent job.

The control device disclosed in JP5840266B includes a display procedure of displaying a control screen which is used to set an execute condition that causes the subsequent job to be executed; a holding procedure of holding an execution result which is acquired by executing the precedent job that is precedent in a recording device used in the control device; an acquisition procedure for acquiring the execution result which is held in the recording device; and a control procedure for controlling execution of the subsequent job, which is subsequent to the precedent job, according to the execution result acquired in the acquisition procedure and the execute condition set through the control screen.

### SUMMARY

In a case where a process, which is formed by cooperating a plurality of execution commands, is executed, the process is executed again or continuously executed after the process is stopped in the middle of being executed due to a malfunction or the like, and setting is performed such that the process is evenly resumed from a specific process, for example, there are problems in that a completely executed process is redundantly executed and in that an inappropriate process, such as a process which is not preferable to be executed again, is executed.

Aspects of non-limiting embodiments of the present disclosure relate to an information processing apparatus and a non-transitory computer readable medium storing a program in which it is possible to suppress execution of the inappropriate process in the case where the process, which includes the series of execution commands, is executed again or the process is continuously executed after the process is stopped in the middle of being executed due to the malfunction or the like.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including: an execution section that executes a series of processes according to an execution instruction which is formed to include a series of execution commands; and an execution control section that, in a case where execution of the series of processes by the execution section is stopped in the middle of the execution and, thereafter, is executed again, controls the execution section to not execute a first process according to a first execution command, which is decided in advance, among the series of execution commands, and to perform re-execution from a second process according to a second execution command other than the first execution command among the series of execution commands.

### BRIEF DESCRIPTION OF THE DRAWINGS

Exemplary embodiment(s) of the present invention will be described in detail based on the following figures, wherein:

FIG. 1 is a block diagram illustrating an example of a control system of an information processing apparatus according to an exemplary embodiment;

FIG. 2 is a diagram illustrating an example of an execution history table;

FIG. 3 is a diagram illustrating an example of a command operation determination table;

FIG. 4 is a flowchart illustrating an example of an operation of the information processing apparatus according to the exemplary embodiment;

FIG. 5 is a diagram schematically illustrating an example of a flow of data;

FIGS. 6A to 6E are diagrams illustrating examples of registration of execution result information in the execution history table;

FIG. 7 is a flowchart illustrating an example of the operation of the information processing apparatus according to the exemplary embodiment;

FIG. 8 is a diagram illustrating an example of the registration of the execution result information in the execution history table; and

FIG. 9 is a diagram illustrating a modification example of the command operation determination table.

### DETAILED DESCRIPTION

Hereinafter, an exemplary embodiment of the present invention will be described with reference to the accompanying drawings. Meanwhile, identical reference symbols are attached to components, which have substantially identical functions, in the drawings, and descriptions thereof will not be repeated.

### Exemplary Embodiment

Configuration of Information Processing Apparatus

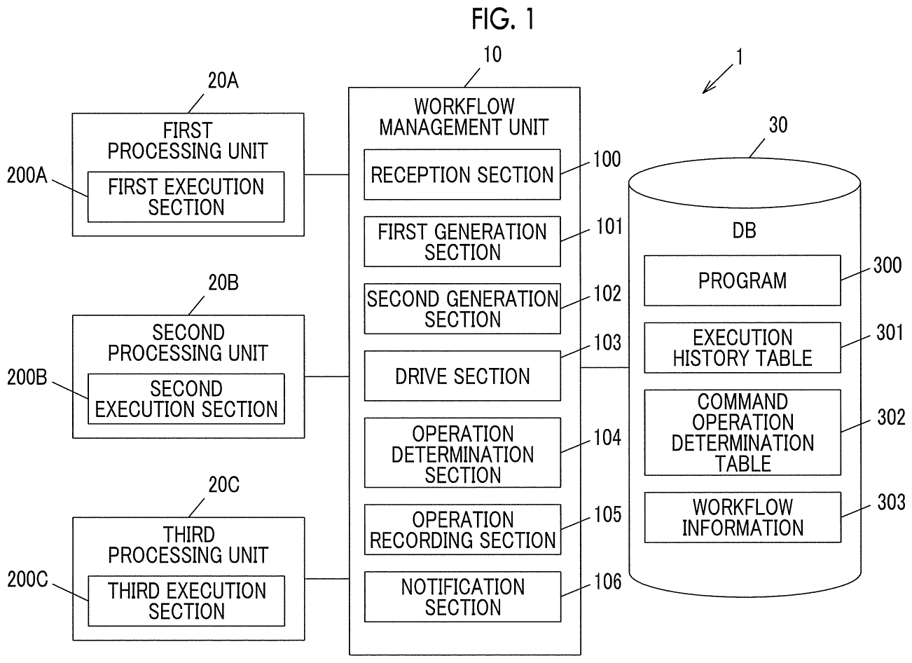

FIG. 1 is a block diagram illustrating an example of a control system of an information processing apparatus according to an exemplary embodiment of the present invention. An information processing apparatus 1 includes a workflow management unit 10 that manages execution of a workflow (which will be described later), first to third processing units 20A to 20C that execute respective processes included in the workflow, and a storage unit (hereinafter, simply referred to a “database” or a “DB”) 30 that stores various data. Meanwhile, hereinafter, in a case where the first to third processing units 20A to 20C are generically referred to, the first to third processing units 20A to 20C are simply referred to as a “processing unit 20”. The database 30 is an example of a storage section.

It is possible to use, for example, a personal computer, a tablet terminal, a multi-functional mobile phone (smartphone), or the like as the information processing apparatus 1. In addition, the processing units 20A to 20C include, for example, a device (that is, an image reading device, an image output device, or the like) which has a function of processing an image, a device (a data transmission device, a mail server device, or the like) which has a function of transmitting and receiving data, and the like.

Meanwhile, although FIG. 1 illustrates an example in which the three processing units 20A to 20C are included, the number of processing units 20 is not limited thereto. The number of processing units 20 may be one, two, or a number which is equal to or larger than four. In addition, the processing units 20A to 20C are not limited to the devices which have the above-described functions, and may be appropriately formed according to content of the workflow to be executed.

In addition, the processing units 20A to 20C and the database 30 may be provided on the outside of the information processing apparatus 1 through, for example, a network (not illustrated in the drawing) such as a Local Area Network (LAN), a Wide Area Network (WAN), the Internet, or an Intranet.

Respective Configurations

Subsequently, respective configurations of the above-described information processing apparatus 1 will be described.

Workflow Management Unit 10

The workflow management unit 10 manages various operations according to the execution of the workflow. Here, the “workflow” refers to a flow of a series of works which are constructed through association with a plurality of processes (hereinafter, referred to as “tasks”) in a fixed unit which is settled. The workflow is an example of a series of processes.

The task further is formed to include at least one or more basic processes (hereinafter, simply referred to as a “basic process”). The basic process is executed according to an execution command (hereinafter, referred to as a “command”) which will be described later. Meanwhile, in the description below, cases where the workflow is formed to include first to third tasks, furthermore, the first task is formed based on one basic process according to a first command, the second task is formed based on one basic process according to a second command, and the third task is formed to include three basic processes according to third to fifth commands, will be described as an example. The basic process is an example of a process according to the execution command.

The workflow management unit 10 includes a Central Processing Unit (CPU), an interface, and the like. The CPU operates according to a program 300 which is stored in the database 30, and functions as a reception section 100, a first generation section 101, a second generation section 102, a drive section 103, an operation determination section 104, an operation recording section 105, a notification section 106, and the like. The operation determination section 104 is an example of an execution control section. The respective sections 100 to 106 will be described in detail later.

Processing Units 20A to 20C

The processing unit 20 executes the task. Specifically, the processing unit 20 continuously executes one or more basic processes, which form the task, in order that is determined in advance based on an instruction from the workflow management unit 10. More specifically, the first processing unit 20A executes the first task, the second processing unit 20B executes the second task, and the third processing unit 20C executes the third task.

That is, the first processing unit 20A executes one basic process according to the first command, the second processing unit 20B executes one basic process according to the second command, and the third processing unit 20C executes three basic processes according to the third to fifth commands. Meanwhile, the present invention is not limited to the examples. The first processing unit 20A may execute a plurality of basic processes, the second processing unit 20B may execute a plurality of basic processes, and the third processing unit 20C may execute one basic process.

The first processing unit 20A includes a first execution section 200A that executes the first task. The second processing unit 20B includes a second execution section 200B that executes the second task. The third processing unit 20C includes a third execution section 2000 that executes the third task. The first to third execution sections 200A to 200C operate, for example, according to a program (that is, a plug-in software or the like) which is capable of being added to the information processing apparatus 1. Meanwhile, in a case where the first to third execution sections 200A to 200C are generically referred to, hereinafter, the first to third execution sections 200A to 200C are simply referred to as an “execution section 200”.

Database 30

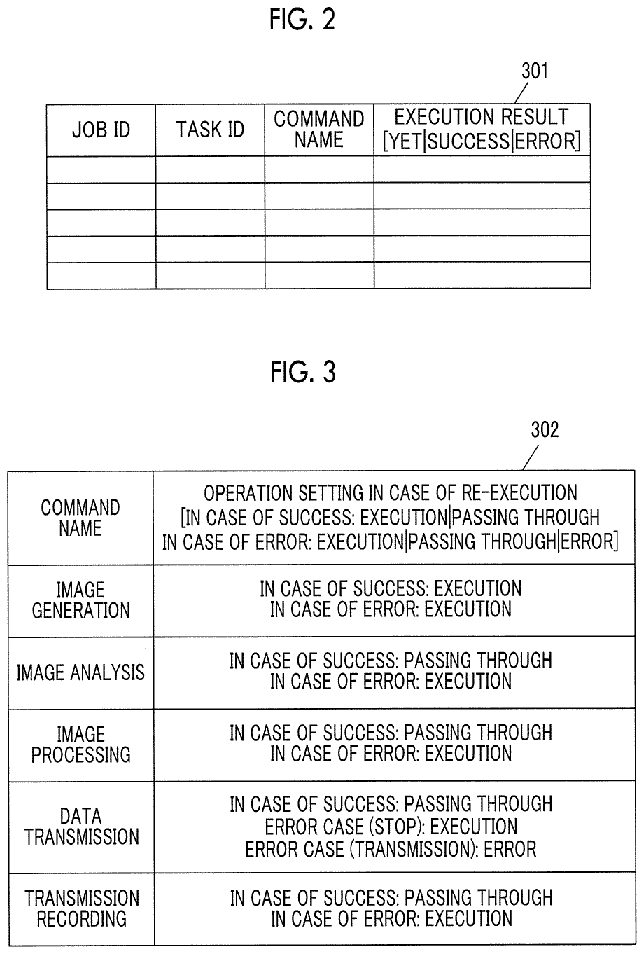

The database 30 includes a Read Only Memory (ROM), a Random-Access Memory (RAM), a hard disk, and the like, and stores various data such as the program 300, an execution history table 301 (refer to FIG. 2), a command operation determination table 302 (refer to FIG. 3), and workflow information 303. Configurations of the tables will be described later.

The workflow information 303 is information registered by associating information which indicates a configuration (that is, the task, the basic process, or the like) of the workflow, information (information (hereinafter, referred to as “execution sequence information”) indicative of a parameter or an execution sequence) which is used to execute the respective processes, and the like with identification information which is used to identify the workflow.

Subsequently, the respective sections 100 to 106, which form the workflow management unit 10, will be described. The reception section 100 receives a demand 4 (hereinafter, simply referred to as a “job generation demand”) for generating an execution instruction (hereinafter, referred to as “a job”) which instructs to execute one workflow based on an operation by an operator (hereinafter, referred to as a “user”). The job generation demand 4 includes, for example, the identification information, such as a name or an ID of the workflow, which is used to identify the workflow.

The first generation section 101 generates the identification information (hereinafter, referred to as a “job ID”), which is given to a job and is used to identify the job, and the job, which is formed to include the workflow information 303 according to a workflow that is designated by the user, in response to the job generation demand 4.

The second generation section 102 generates a command which is used to execute the workflow according to the job and execution instruction information of the command. The command includes various pieces of information which are used to execute the basic processes that form the workflow.

The drive section 103 drives the first to third processing units 20A to 20C, respectively, according to the execution sequence information of the workflow. Meanwhile, “drive” indicates, for example, to cause a state in which it is possible to execute a process by the processing unit 20.

In a case where it is instructed to execute the workflow again after the workflow is stopped in the middle of being executed due to malfunction or the like, the operation determination section 104 determines a method for treating the respective basic processes which are form the workflow, that is, whether or not to execute the basic processes again in a case of re-execution of the workflow.

Specifically, the operation determination section 104 acquires information (hereinafter, referred to as “execution result information”), which indicates a result of the execution, from the execution history table 301 stored in the database 30. In addition, the operation determination section 104 collates the acquired execution result information with information, which is recorded in the command operation determination table 302 stored in the database 30, and determines whether or not to execute the basic process again in a case where the workflow is executed again. The execution result information is an example of result information.

Meanwhile, in a case where the workflow is executed again after the workflow is stopped in the middle of being executed, the workflow may be resumed from a leading basic process of the task which includes a stopped process, or the workflow may be evenly resumed from a leading basic process of the workflow, that is, a basic process which forms the first task.

The operation recording section 105 records the execution result information in the execution history table 301 in association with the job ID, the identification information (hereinafter, referred to as “task ID”) which is used to identify the task, and information (hereinafter, simply referred to as a “command name”) which indicates a name of the command. Hereinafter, task IDs according to the first, second tasks are respectively referred to as “Task1”, “Task2”,

In a case where the workflow, which is being executed, is stopped in the middle of being executed due to some reasons, the notification section 106 outputs a warning using, for example, a well-known way, such as a sound (alarm), a voice, a mail notification, a message notification, or LED, and notifies that the workflow is stopped in the middle of being executed (that is, an error is generated) to the user.

Configuration of Table

FIG. 2 is a diagram illustrating an example of the execution history table 301. The execution history table 301 is a table in which the execution result information is recorded for each basic process. In the execution history table 301, a “job ID” field, a “task ID” field, a “command name” field, and an “execution result” field are provided.

In the “command name” field, the name of the command corresponding to the basic process to be executed is recorded. In the “execution result” field, the execution result information is recorded using a character string, such as “yet” (not yet processed), “success”, or “error”, or a symbol according to a result of the process.

FIG. 3 is a diagram illustrating an example of the command operation determination table 302. In a case where it is instructed to execute the workflow again after the workflow is stopped in the middle of being executed, the command operation determination table 302 records information which indicates whether or not to execute the basic process that forms the workflow.

In the command operation determination table 302, the “command name” field and an “operation setting in case of re-execution” field are provided. In the “command name” field, the name of the command corresponding to the basic process to be executed is recorded. In the “operation setting in case of re-execution” field, information (hereinafter, referred to as “operation information in case of re-execution”), which indicates whether or not to execute the basic process, is recorded in a case where it is instructed to execute the workflow again. The command name is an example of the identification information which is used to identify the execution command. The operation information in case of re-execution is an example of the operation information.

For example, an example of an image processing workflow will be described. In the command operation determination table 302, setting is performed for operations in the case where the re-execution is performed after malfunction is generated in a process. In an example of image generation, setting is performed such that an identical process is performed again either in a case where a previous process is successful or in a case where the previous process is erroneous. In an example of image analysis, setting is performed such that the process ends without performing any image analysis process in the case where the re-execution is performed and the previous process is successful, and such that the image analysis process is performed in the case where the previous process is erroneous.

In the “operation setting in case of re-execution” field, for example, “passing through” is recorded in a case where it is instructed to re-execute a process, which is executed once in the workflow, and the basic process is not executed again, for example, “execution” is recorded in a case where it is instructed to execute the workflow again and the basic process is executed again, and, for example, “error” is recorded in a case where it is instructed to execute the workflow again and the warning is output while the basic process is not executed again.

Meanwhile, as illustrated in FIG. 3, division is performed on the operation information in case of re-execution according to whether the workflow, which includes the process that is stopped in the middle of being executed, is being executed (that is, a first workflow is being executed), the basic process is successful, or the error is generated. The operations in the case of re-execution, that is, “execution”, “passing through”, and “error” are defined.

A command, which is used to execute the basic process defined as “passing through”, and a command, which is used to execute the basic process recorded as “error”, are examples of a first execution command. A command, which is used to execute the basic process recorded as “execution”, is an example of a second execution command. The basic process recorded as “passing through” and the basic process recorded as “error” are examples of a first process. The basic process recorded as “execution” is an example of a second process.

Operation According to Exemplary Embodiment

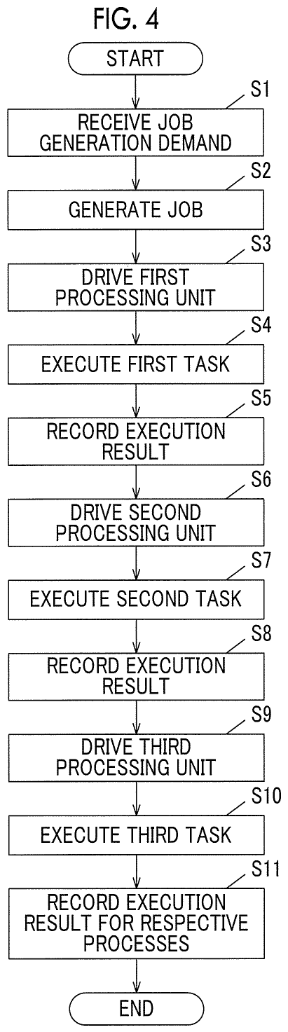

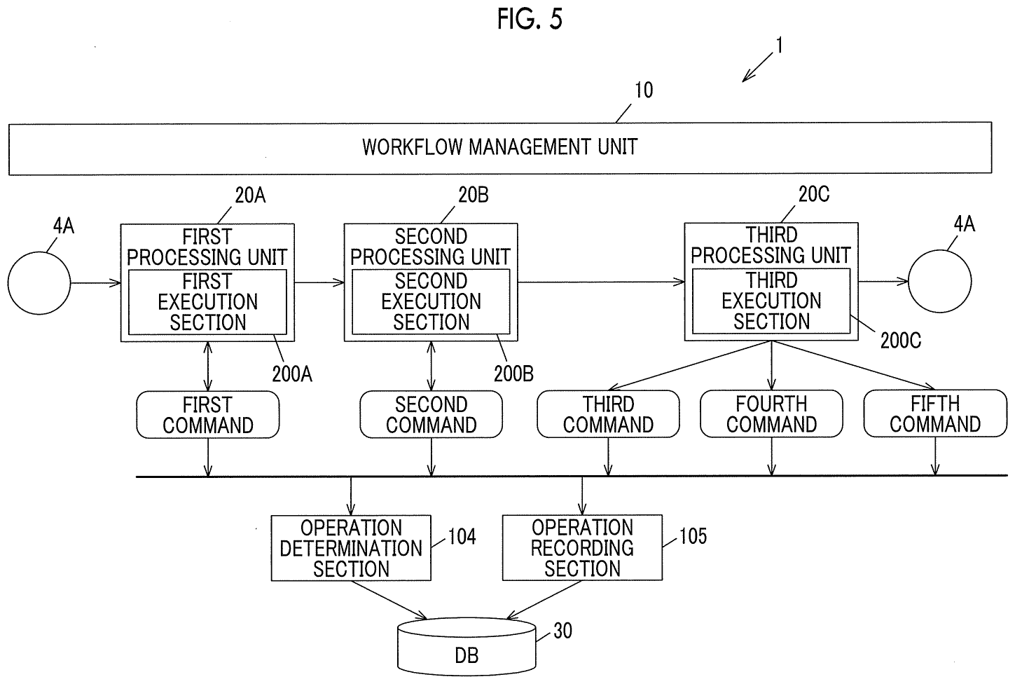

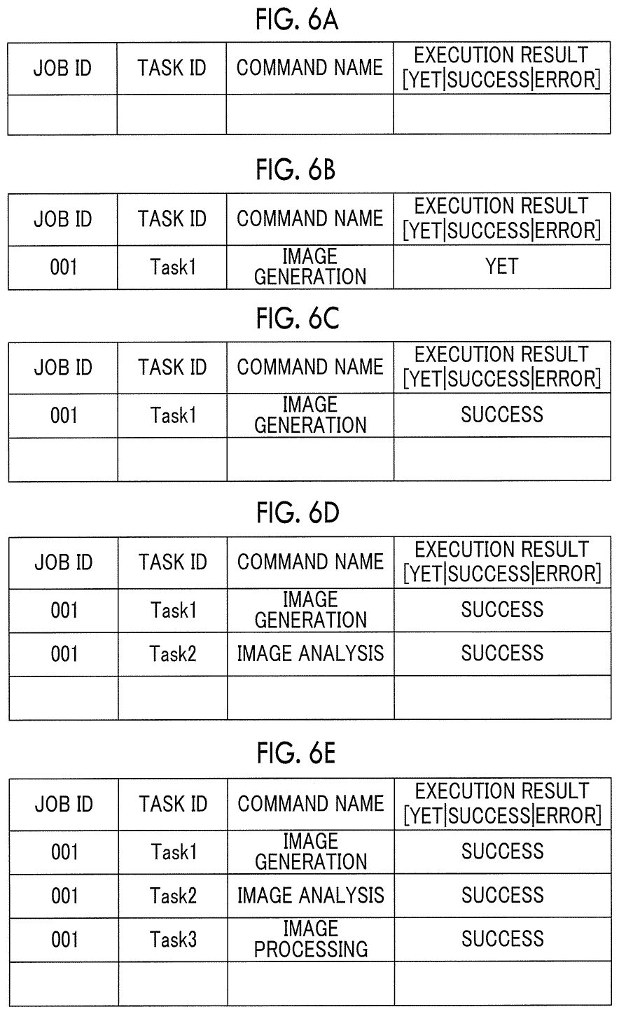

Subsequently, an example of an operation of the information processing apparatus 1 will be described with reference to FIGS. 4, 5, and 6A to 6E. FIG. 4 is a flowchart illustrating the example of the operation of the information processing apparatus 1 according to the exemplary embodiment. FIG. 5 is a diagram schematically illustrating an example of a flow of data. Arrows illustrated in FIG. 5 indicate the flow of the data. Details will be described with the example of the operation which will be described later. FIGS. 6A to 6E are diagrams illustrating examples of registration of the execution result information in the execution history table 301. Meanwhile, hereinafter, a workflow, which is formed to include the image generation, the image analysis, image processing, data transmission, and transmission recording, will be described using an example of a case where the first processing unit 20A executes the image generation, the second processing unit 20B executes the image analysis, and the third processing unit 20C executes the image processing, the data transmission, and the transmission recording.

The image generation is an example of the first task. The image analysis is an example of the second task. The image processing, the data transmission, and the transmission recording are examples of the third task. The image generation, the image analysis, the image processing, the data transmission, and the transmission recording are examples of the basic processes, respectively.

The first task is executed according to an image generation command. The second task is executed using an image analysis command according to the image analysis. The third task is executed using an image processing command according to the image processing, a data transmission command according to the data transmission, and a transmission recording command according to the transmission recording, respectively.

The image generation command is an example of the first command. The image analysis command is an example of the second command. The image processing command is an example of the third command. The data transmission command is an example of the fourth command. The transmission recording command is an example of the fifth command. Hereinafter, description will be performed with two separate operations, that is, (1) an operation performed in a case where the workflow ends without being stopped in the middle of being executed and (2) an operation performed in a case where the workflow is re-executed in a case where the workflow is stopped in the middle of being executed due to malfunction.

(1) Operation Performed in Case where Workflow Ends without being Stopped in Middle of being Executed

In a case where the user performs the job generation demand 4 by designating a name of the workflow (hereinafter, simply referred to as a “workflow name”) with respect to the information processing apparatus 1, the reception section 100 receives the job generation demand 4 (S1). The first generation section 101 generates the job together with the job ID according to the job generation demand 4 which is received by the reception section 100 (S2).

The drive section 103 drives the first processing unit 20A (S3). The first execution section 200A executes the first task (image generation) while using the job ID and the task ID as parameters (S4). In the exemplary embodiment, the second generation section 102 generates the image generation command, and the first execution section 200A executes a process (hereinafter, referred to as “first basic process”) of generating an image according to the image generation command.

In a case where a process according to the image generation command ends, the operation recording section 105 records the execution result in the execution history table 301 (S5). Specifically, as illustrated in FIG. 6C, the operation recording section 105 records “success” in a column corresponding to the “execution result” field of the execution history table 301.

Meanwhile, as illustrated in FIG. 6A, no information is recorded in the execution history table 301 in an initial state, and thus the respective fields of the execution history table 301 are kept as blank fields. In addition, as illustrated in FIG. 6B, in a case after the first basic process starts, that is, before the first basic process ends, the execution result is “yet” (not yet executed).

Subsequently, the drive section 103 drives the second processing unit 20B (S6). The second execution section 200B executes the second task (image analysis) (S7). In the exemplary embodiment, the second generation section 102 generates the image analysis command, and the second execution section 2008 executes the process (hereinafter, referred to as a “second basic process”) of analyzing the image according to the image analysis command.

In a case where the second basic process ends, the operation recording section 105 records the execution result in the execution history table 301 (S8). Specifically, as illustrated in FIG. 6D, the operation recording section 105 records “success” in a column corresponding to the “execution result” field of the execution history table 301.

Subsequently, the drive section 103 drives the third processing unit 20C (S9). The third execution section 200C executes the third task (the image processing, the data transmission, and the transmission recording) (S10). In the exemplary embodiment, the second generation section 102 generates the image processing command, the data transmission command, and the transmission recording command, and the third execution section 200C executes a process (hereinafter, referred to as a “third basic process”) of processing the image according to the image processing command, executes a process (hereinafter, referred to as a “fourth basic process”) of transmitting the data according to the data transmission command, and executes a process (hereinafter, referred to as a “fifth basic process”) of recording a fact that the data is transmitted according to the transmission recording command.

In a case where the third to fifth basic processes end, the operation recording section 105 records the execution results in the execution history table 301 for the respective third to fifth basic processes (S11). Specifically, as illustrated in FIG. 6E, the operation recording section 105 records “success” in a column corresponding to the “execution result” field of the execution history table 301.

In other words, the reception section 100 receives the job generation demand 4 (S1), the first generation section 101 generates the job (S2), the drive section 103 drives an N-th (N is a natural number) processing unit 20 (S3, S6, and S9), the second generation section 102 generates one or more commands (S4, S7, and S10), the execution section 200 of an N-th (N is a natural number) processing unit 20 executes the basic process according to the command, and the operation recording section 105 records the execution results in the execution history table 301 for respective executed basic processes (S5, S8, and S11).

(2) Operation in Case where Workflow is Stopped in Middle of being Executed and is Re-Executed

A case where the workflow is stopped in the middle of being executed and is re-executed is described using a case where the workflow is stopped in the middle of execution of the third task in the third processing unit 20C due to some reasons and is re-executed as an example. Meanwhile, unless being described specifically, it is assumed that the first task and the second task normally end (that is, the execution result is recorded as “success”). In a case where it is instructed to execute the workflow again, description will be performed while it is assumed that the workflow is resumed from a leading basic process among the plurality of basic processes which form the third task in which stop is generated. In addition, three examples, that is, (2-1) a case where the third processing unit 20C is stopped, (2-2) a case where the error is generated during the data transmission, and (2-3) a case where the error is generated during the image processing will be described.

(2-1) Case where Third Processing Unit 20C is Stopped

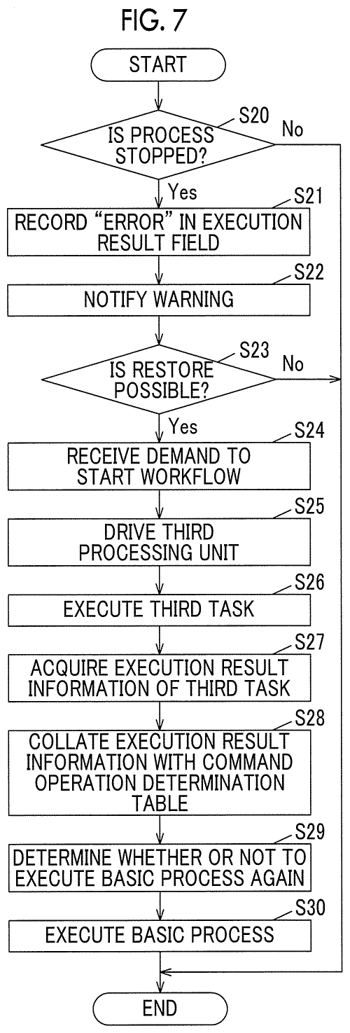

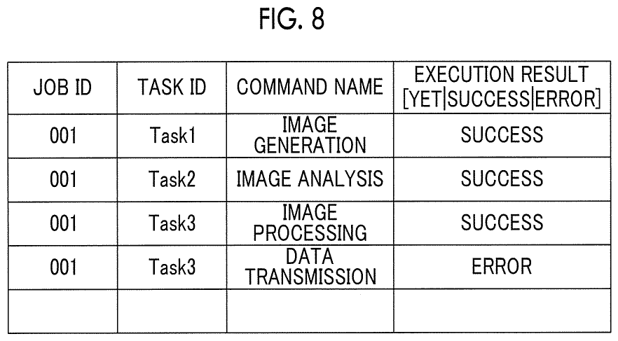

FIG. 7 is a flowchart illustrating an example of the operation of the information processing apparatus 1. FIG. 8 is a diagram illustrating an example of registration of the execution result information in the execution history table 301. Meanwhile, it is assumed that operations, which are identical to steps S1 to S9 that are described above, are performed at the beginning of FIG. 7, and the description thereof will not be repeated.

In a case where the process is stopped in the middle of the third task because the third processing unit 20C (for example, the data transmission device) is stopped after the first and second tasks are executed (S20: Yes), the operation recording section 105 records “error” in a column corresponding to the “execution result” field, together with the job ID, the task ID, and the command name (data transmission command) (S21), as illustrated in FIG. 8.

The notification section 106 notifies that the error is generated by outputting the warning (S22). In a case where it is possible to restore the third processing unit 20C (S23: Yes) and a demand to execute the workflow is provided again based on an operation by the user after a reason why the error is generated is removed by the user and the third processing unit 20C is restored, the reception section 100 receives the execution demand (S24).

The drive section 103 drives the third processing unit 20C again (S25). The third execution section 200C of the third processing unit 20C executes the third task again (S26). Specifically, the third execution section 200C starts the third basic process (that is, a process of processing an image) which is the leading basic process of forming the third task.

The operation determination section 104 acquires the execution result information of the basic process according to the third task, in which stop is generated, from the execution history table 301 which is stored in the database 30 (S27). Specifically, in a case where a record exists in the “execution result” field among the basic processes (in the exemplary embodiment, the basic processes, that is, the image processing, the data transmission, and the transmission recording) according to the third task (“Task3”) from the execution history table 301 illustrated in FIG. 8, the operation determination section 104 acquires the recorded execution result information. Meanwhile, the operation determination section 104 may not acquire the execution result information for the “execution result” field (in the example illustrated in FIG. 7, a result according to record of the transmission) which is empty as the process does not start because the workflow is stopped in the middle of being executed.

Subsequently, the operation determination section 104 collates the acquired execution result information with information which is recorded in the command operation determination table 302 stored in the database 30 (refer to FIG. 4) (S28).

The operation determination section 104 determines whether or not to execute the respective basic processes, which form the third task, again in a case where the workflow is executed again (S29). Specifically, the operation determination section 104 determines the image processing as “passing through” because the execution result information of “image processing” is “success”, and determines the data transmission as “execution” because the execution result information of “data transmission” is “error (stop)”.

The third execution section 200C executes the respective basic processes according to a result of the determination by the operation determination section 104 (S30). Specifically, the third execution section 200C executes not yet executed data transmission and transmission recording without executing the image processing again.

(2-2) Case where Error is Generated During Data Transmission

In the case where the error is generated during the data transmission, a result of the determination by the operation determination section 104 in the above-described step S29 differs from a case where the above-described third processing unit 20C is stopped. Description will be performed based on the operation corresponding to step S29. Since other steps S20 to S28 are identical, detailed description will not be repeated.

The operation determination section 104 collates the acquired execution result information with the information (refer to FIG. 4) which is recorded in the command operation determination table 302 stored in the database 30. Subsequently, the operation determination section 104 determines the image processing as “passing through” because the execution result information of the “image processing” is “success”, and determines the data transmission as “error” because the execution result information for the “data transmission” is “error (transmission)”.

The third execution section 200C does not execute the image processing and the data transmission again, and the notification section 106 notifies that the error is generated in the data transmission to the user by outputting the warning. The notification section 106 may further notify a message used to urge the user to redo the workflow.

(2-3) Case where Error is Generated During Image Processing

In a case where the error is generated during the data transmission, the result of the determination by the operation determination section 104 in the above-described step S29 differs from the case where the above-described third processing unit 20C is stopped. Description will be performed based on the operation corresponding to step S29. Since other steps S20 to S28 are identical, detailed description will not be repeated.

The operation determination section 104 collates the acquired execution result information with the information (refer to FIG. 4) which is recorded in the command operation determination table 302 that is stored in the database 30. Subsequently, the operation determination section 104 determines the image processing as “execution” because the execution result information of the “image processing” is “error”.

The third execution section 200C executes the image processing again, and subsequently executes the processes corresponding to the data transmission and the transmission recording.

In the above-described three examples, the process of the third processing unit 20C, that is, a fact that the error is generated during the execution of the third task is described as an example. However, operations, which are performed in the process of the first processing unit 20A, that is, a case where the error is generated during the execution of the first task and the process of the second processing unit 20B, that is, a case where the error is generated during the execution of the second task, are substantially identical to the above-described operations.

### MODIFICATION EXAMPLE

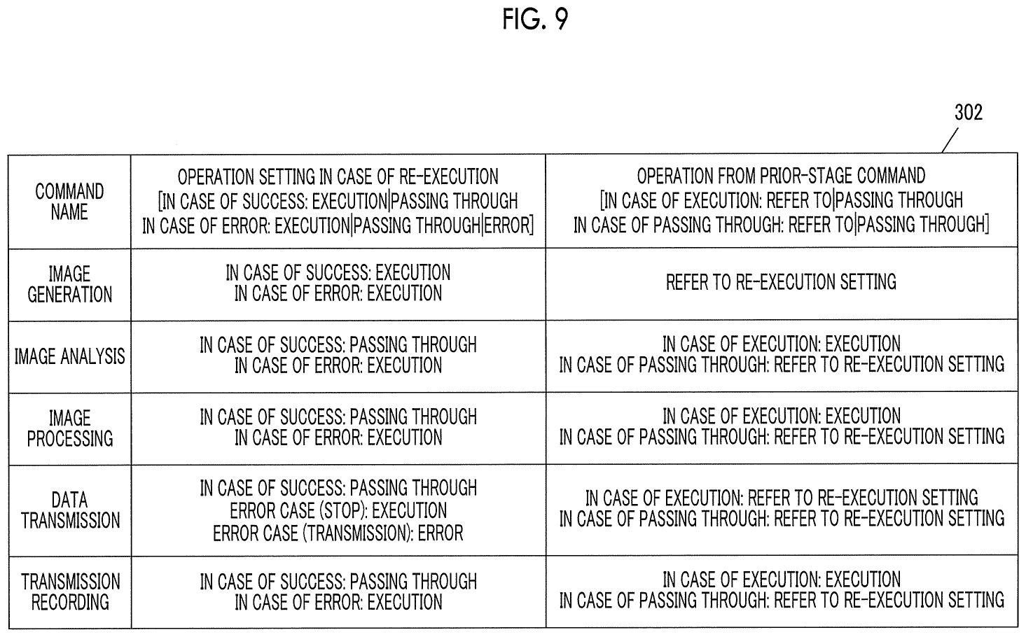

FIG. 9 is a diagram illustrating a modification example of the command operation determination table 302. As illustrated in FIG. 9, in addition to the fields illustrated in FIG. 4, for example, an “operation from prior-stage command” field may be further provided to the command operation determination table 302. In the “operation from prior-stage command” field, information relevant to whether or not to execute the basic process again is recorded according to a result of a basic process, which is performed immediately before the basic process. The prior-stage command is an example of a third execution command. The basic process according to the prior-stage command is an example of a third process. The command operation determination table 302 is an example of an association section.

In a case where the basic process is executed, for example, “execution” is recorded. In a case where determination is performed depending on the result of the basic process, “refer to re-execution setting” or the like is recorded.

The operation determination section 104 refers to the “operation from prior-stage command” field of the command operation determination table 302. In a case where “refer to re-execution setting” is recorded in the “operation from prior-stage command” field, the operation determination section 104 refers to the “re-execution setting” field. In addition, the operation determination section 104 collates the acquired execution result information with information, which is recorded in the “re-execution setting” field, and determines whether or not to execute the basic process again.

Hereinabove, the exemplary embodiment of the present invention is described. However, the exemplary embodiment of the present invention is not limited to the above exemplary embodiment, and various modifications and implementations are possible in a scope without departing from the gist of the present invention. The image processing may include, for example, movement of an image, rotation, noise removal, specific shape recognition, text information extraction (for example, OCR process), file format conversion, and the like.

Some or all of the respective sections of the workflow management unit 10 may be formed using a hardware circuit such as a Field Programmable Gate Array (FPGA) or an Application Specific Integrated Circuit (ASIC).

In addition, it is possible to omit or change some of components according to the exemplary embodiment in the scope without changing the gist of the present invention. In addition, it is possible to add, remove, change, and substitute a step in the flow according to the exemplary embodiment in the scope without changing the gist of the present invention. In addition, it is possible to provide the program used in the exemplary embodiment after recording the program in a computer-readable recording medium, such as a CD-ROM, and it is possible to store the program in an external server, such as a cloud server and to use the program through the network.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an execution section that executes a series of processes according to an execution instruction which is formed to include a series of execution commands; and
an execution control section that, in a case where execution of the series of processes by the execution section is stopped in the middle of the execution and, thereafter, is executed again, controls the execution section to not execute a first process according to a first execution command, which is decided in advance, among the series of execution commands, and to perform re-execution from a second process according to a second execution command other than the first execution command among the series of execution commands.

2. The information processing apparatus according to claim 1, further comprising:
a recording section that records identification information which is used to identify the first execution command, and result information which indicates an execution result of the execution of the execution command executed by the execution section,
wherein the execution control section controls the execution section according to the identification information and the result information which are recorded in the recording section.

3. The information processing apparatus according to claim 2,
wherein the recording section records operation information which indicates whether or not to perform, according to the result information, the re-execution for each of the execution commands included in the series of execution commands, and
wherein the execution control section controls the execution section according to the operation information corresponding to the result information.

4. The information processing apparatus according to claim 1,
wherein the execution control section specifies whether or not to execute the first process again according to an execution result of a third process according to a third execution command immediately before the first execution command in the series of execution commands.

5. The information processing apparatus according to claim 2,
wherein the execution control section specifies whether or not to execute the first process again according to an execution result of a third process according to a third execution command immediately before the first execution command in the series of execution commands.

6. The information processing apparatus according to claim 3,
wherein the execution control section specifies whether or not to execute the first process again according to an execution result of a third process according to a third execution command immediately before the first execution command in the series of execution commands.

7. The information processing apparatus according to claim 4, further comprising:
an association section that associates first operation information according to the first process with second operation information according to the third process.

8. The information processing apparatus according to claim 5, further comprising:
an association section that associates first operation information according to the first process with second operation information according to the third process.

9. The information processing apparatus according to claim 6, further comprising:
an association section that associates first operation information according to the first process with second operation information according to the third process.

10. A non-transitory computer readable medium storing a program causing a computer to function as:
an execution section that executes a process according to an execution instruction which is formed to include a series of execution commands; and
an execution control section that, in a case where execution of the process by the execution section is stopped in the middle of the execution and, thereafter, is executed again, controls the execution section to not execute a first execution command, which is decided in advance, among the series of execution commands, and to perform re-execution from a second execution command other than the first execution command among the series of execution commands.

11. An information processing apparatus comprising:
execution means for executing a series of processes according to an execution instruction which is formed to include a series of execution commands; and
execution control means for, in a case where execution of the series of processes by the execution means is stopped in the middle of the execution and, thereafter, is executed again, controlling the execution means to not execute a first process according to a first execution command, which is decided in advance, among the series of execution commands, and to perform re-execution from a second process according to a second execution command other than the first execution command among the series of execution commands.
